(19) United States
(12) Patent Application Publication
(10) Pub. No.: US 2017/0132659 A1
(43) Pub. Date: May 11, 2017

(54) Potential Revenue of Video Views

(71) Applicant: Google Inc., Mountain View, CA (US)

(72) Inventors: William Martin Dirks, San Francisco, CA (US); Stephen John Andrew Tracy, New York, NY (US); Armand Joseph Dijamco, San Francisco, CA (US); Philippe Farhi, San Francisco, CA (US); Romit Jadhwani, San Jose, CA (US); Gabriel Jason Kronstadt, Singapore (SG); Eli Spencer Danziger, San Francisco, CA (US)

(73) Assignee: Google Inc., Mountain View, CA (US)

(21) Appl. No.: 14/153,860

(22) Filed: Jan. 13, 2014

(51) Int. Cl. G06Q 30/02

(52) U.S. Cl. CPC G06Q 30/0247

(57) ABSTRACT

A method, executed on a processor, for computing potential revenue from video program views, includes receiving ad availabilities in video programs; receiving an identification of each of one or more ad requests based on an ad availability in a video program, each ad request defined by one or more factors i and an ad format m of an ad requested, the ad requests defining the video program as one or more monetizable views; receiving, or each of the one or more factors i, a revenue term; and determining, based on the ad format m and the revenue term, total potential revenue from an advertisement served in the ad availability.

### BACKGROUND

Some media publishers provide streaming videos from Internet Web pages. An individual may enter a search term related to a type or genre of a video, may access a video subscription page, or otherwise may request delivery of a video to the individual's media device. The delivered video may be displayed in a video player on a video watch page.

A video publisher may generate revenue by displaying advertisements on video watch pages. However, not every displayed video is accompanied by an advertisement. Furthermore, even when advertisements are served with the display of a video, the highest value ad is not necessarily displayed.

### SUMMARY

A method, executed on a processor, for computing potential revenue from video program views, includes receiving ad availabilities in video programs; receiving an identification of each of one or more ad requests based on an ad availability in a video program, each ad request defined by one or more factors i and an ad format m of an ad requested, the ad requests defining the video program as one or more monetizable views; receiving, for each of the one or more factors i, a revenue term; and determining, based on the ad format m and revenue term, total potential revenue from an advertisement served in the ad availability.

A processor-implemented method for computing a potential revenue from advertising availabilities in video programs, includes receiving, at the processor, an ad request and an ad availability from which the ad request was generated, the ad availability appearing in a video program; receiving one or more factors constituting the ad request; receiving an ad format as a most lucrative ad format; for each factor, computing potential revenue of an advertisement served in the ad availability, comprising: computing a revenue term value based on the factors, and counting a number of monetizable views of the video program; and summing the potential revenue across all factors.

A system for determining potential revenue that may be derived from viewing of an advertisement in a video program includes a non-transitory computer readable storage medium having embedded thereon machine instructions for determining the potential revenue; and a processor that executes the instructions to cause: reception of an ad availability in a viewed video program, reception of an identification of each of one or more ad requests based on the ad availability in the viewed video program, each ad request defined by one or more factors i and an ad format of an ad requested for service in the ad availability, the ad requests defining the ad availability as one or more monetizable views i, access to the identified ad requests, determination of an ad format m specified in each of the ad requests and one or more factors i defining each of the ad requests, reception, for each of the one or more factors i, of a revenue term, and determination, based on the ad formats m, of the potential revenue from an advertisement served in the ad availability as the sum of the monetizable views; multiplied by a revenue term.

### DESCRIPTION OF THE DRAWINGS

The detailed description refers to the following figures in which like numerals refer to like items, and in which:

FIGS. 1A and 1B illustrate example environments in which potential revenue and missed revenue from media delivery may be computed and used;

FIGS. 2A-2E illustrate example Web pages on which static and video advertisements may be served;

FIGS. 3A and 3B illustrate example resources at which video advertisements may be served;

FIGS. 4A and 4B illustrate additional example resources at which video advertisements may be served;

FIG. 5 illustrates an example system for determining potential and missed revenue from advertisements served with videos in a video delivery system;

FIGS. 6A-7B are flowcharts illustrating example methods for determining potential and missed revenue from advertisements served with videos in a video delivery system; and

FIG. 8 is a flowchart illustrating an alternative method for determining potential and missed revenue.

### DETAILED DESCRIPTION

Media publishers may provide various types of media having advertising availabilities in which advertisements may be served. Media publishers include traditional television program broadcasters and online streaming video delivery systems, for example. Some media publishers provide streaming videos from Internet Web pages. An individual may enter a search term related to a type of video, may access a video subscription page, or otherwise may request delivery of a video program to the individual's media device. The delivered video program may be displayed in a video player on a video watch page.

A media publisher operating a video delivery system may generate revenue by displaying, or enabling the display of, advertisements on video watch pages in conjunction with the display of a video program. However, not every displayed video program is accompanied by an advertisement. In some situations, advertisements are not enabled in a video program. In other situations, advertisements are not allowed in a video program. In still other situations, advertisements are not requested. Furthermore, even when advertisements are served and displayed with the display of a video program, the highest value advertisement is not necessarily selected, served, and displayed at the video watch page. Thus, some potential revenue may be missed.

Disclosed herein are systems and methods for determining potential revenue from video views in which an advertisement (i.e., a monetizable event) may be served. In an aspect, the systems and methods also provide for determining missed revenue by calculating the potential amount of revenue achievable per video view and comparing that amount to the actual revenue received.

As used herein, a view may be a display of a video program, whether or not the video program includes an advertisement availability. In an aspect, a monetized view includes a display of a video program in which a video advertisement is served and runs for at least a minimum threshold time. The minimum threshold time may vary from zero seconds (e.g., the video advertisement is skipped entirely and only a thumbnail image of the video advertisement is displayed) up to the full length of the video advertisement. A monetizable view may be one in which an advertisement may be served. A monetizable view may be considered to be enabled when the video program includes advertising inventory (referred to hereafter as an advertising availability), but no ad request is made because of a constraint imposed outside the control of the video delivery system (e.g., the video program is displayed in a country that does not allow advertisements, or the media device on which the video program is displayed has an ad blocker installed). A monetizable view may be considered to be allowed when the video program includes an advertising availability but an advertisement is not served because of a constraint imposed by the video delivery system. An impression may be an advertisement that is served with a video program. Multiple impressions may occur with a display of a video program. An ad request may be initiated from a viewer's media device when a video program having an advertising availability is displayed on the viewing device.

A non-monetizable view may be one in which an advertisement may not (e.g., for legal reasons) be requested or served, or cannot (e.g., for technical reasons) be served. For example no ad request may be made because of a constraint imposed outside the control of the video delivery system (e.g., the video program is displayed in a country that does not allow advertisements, or the media device on which the video program is displayed has an ad blocker installed).

The systems may parse the views into categories based on a number of factors such as the viewer's country; a video vertical, such as a theme, genre, or other grouping mechanisms; demographics; and the ad format type of advertisement requested and served, for example. In an aspect, therefore, potential revenue from an advertisement availability may be based on one or more of each of a content factor, a viewer factor and an ad factor (or ad format).

A content factor may refer to the subject matter of a video program in which an ad may appear (e.g., sports, professional sports, professional football, etc.). A viewer factor may include viewer location (e.g., country, state, city, zip code), age, gender, and other demographic factors. An ad factor may refer to an ad format (e.g., pre-roll, instream, overlay) and the ad sales mechanism (e.g., auction, sales, double click).

Some factors may overlap other factors, either partially or wholly. For example, the factor sports fans may wholly overlap the factor college football, and the factor males may partially overlap the factor sports fans.

The systems may be implemented on a single server. Alternately, the systems may be implemented in a dispersed server network including a network in which the servers are in geographically-separated locations.

The systems may be used to compute and use one or more revenue-based metrics, such as potential revenue, total revenue, actual revenue, and missed revenue, as discussed below.

In an embodiment, the systems may compute and use potential revenue, as follows:
Count the number of video views where an ad request was made for a time period of interest (day, week, month, quarter, year). In an aspect, these views may be considered monetizable views.
Estimate the value of a revenue term (e.g., revenue per thousand impressions (RPM), where revenue per 1000 impressions represents the estimated earnings that would accrue for every 1000 page views, assuming one ad in one page view). This estimate may be based on historical revenue data. Other revenue terms, such as cost per mille (CPM) also may be used.
Calculate total potential revenue as the sum of the monetizable views, times a revenue term, such as RPMᵢ, where the sum is taken over any number of content and demographic factors i including gender and country, as well as the most lucrative ad format m requested. Monetizable views is the number of monetizable views with that factor i (e.g., gender, country), and ad format m, and RPM; is the revenue term for that factor (gender, country, ad format).

In another embodiment, the systems may compute potential revenue based on all video views, enabled video views, allowed video views, requested advertisements, or served advertisements, or any combination of video views.

In yet another embodiment, the potential revenue calculation may consider an aggregate RPM value, where the aggregate RPM takes into account overlapping factors. That is, as noted in an example above, the demographic factor males may overlap partially with the content factor sports fans, and sports fans could overlap football fans and basketball fans. The correct RPM to use with sports fans, for example, may not be simply the sum of the RPMs for football and basketball fans. Furthermore, some football fans also are basketball fans. Thus, many factors may overlap, which add complexity in determining potential revenue since ad availabilities are not mutually exclusive.

A video delivery system may use the potential revenue metric to determine where the potential exists to grow revenue. For example, if for a particular video vertical (genre) in a particular country, the video delivery system has a large potential revenue but a small actual revenue, the operator of the video delivery system may focus its advertising sales efforts on the video vertical in the particular country.

In an embodiment, the value of revenue term RPM may be calculated by dividing estimated earnings by the number of Web page views and then multiplying the result by 1000. For example, if the video delivery system earned an estimated $0.15 from 25 Web page views, then the Web page RPM would equal ($0.15/25)*1000, or $6.00. The systems may generate an RPM estimate for each viewer, gender, and ad format in each country in which the video delivery system sells advertisements. The systems also may generate RPM estimates for composite products, such as (gender and age group). The RPM estimates may be updated for different time periods.

As a further example, consider a scenario in which, for a specific day, there were 1023 views of a specific video having an advertising availability in the U.S. Of these 1023 views, 970 views resulted in a request for at least one impression, and thus the 970 views were marked monetizable; 600 of the 970 views requested, as a most lucrative ad format, an instream advertisement; 400 of the 600 views were made by males, 150 by females, and 50 by people of unknown gender. The remaining 370 views asked for an overlay advertisement as a most lucrative ad format, and all 370 ad requests were made by females. The potential revenue for the U.S. then would be:

400*18/1000+150*17/1000+50*10/1000+370*8/1000=$13.16, where

RPM for (US, male, instream)=$18;

RPM for (US, female, instream)=$17;

RPM for (US, unknown, instream)=$10;

RPM for (US, female, overlay)=$8.

In the above-described example, a system calculates monetizable views as a number of views where an advertisement was requested. As an alternative, as noted above, the system may determine the number of monetizable views as a number of views in which an advertisement was served. As another alternate, the system may determine the potential number of views where an advertisement could have been served. Examples of this later alternative may include analysis of some or all of the following views:
All views.
Number of views that are enabled for serving an ad. That is, a video program may be enabled for serving an advertisement but no ad request was made before, during, or after display of the video program. There may be any number of reasons why no ad request was made. For example, the country in which the video program was displayed may not allow ads, or the viewer may have an ad blocker installed in his media device.
Number of views that are allowed to serve a video advertisement. In this scenario, the video program is enabled to serve advertisements and there are no legal reasons that prevent an advertisement from being requested. However, an advertisement may not be selected because the video delivery system imposes a constraint on the number of advertisements served over a specified period, and the viewer just recently watched an advertisement.

As noted above, in an aspect, the systems use only the most lucrative ad format requested as the measure of potential revenue for an advertising availability. In another aspect, however, the systems may improve the potential revenue estimates by taking into account multiple advertisements being served on a Web page. For example, for a specific view, the systems could estimate the probability of an overlay ad being served when an instream advertisement is requested as P. The systems then could, when an instream ad is requested, calculate potential revenue based on a revenue term of the different ad formats and the probability that such an ad format would be used. This process could be expanded to give potential revenue of views with multiple advertisements.

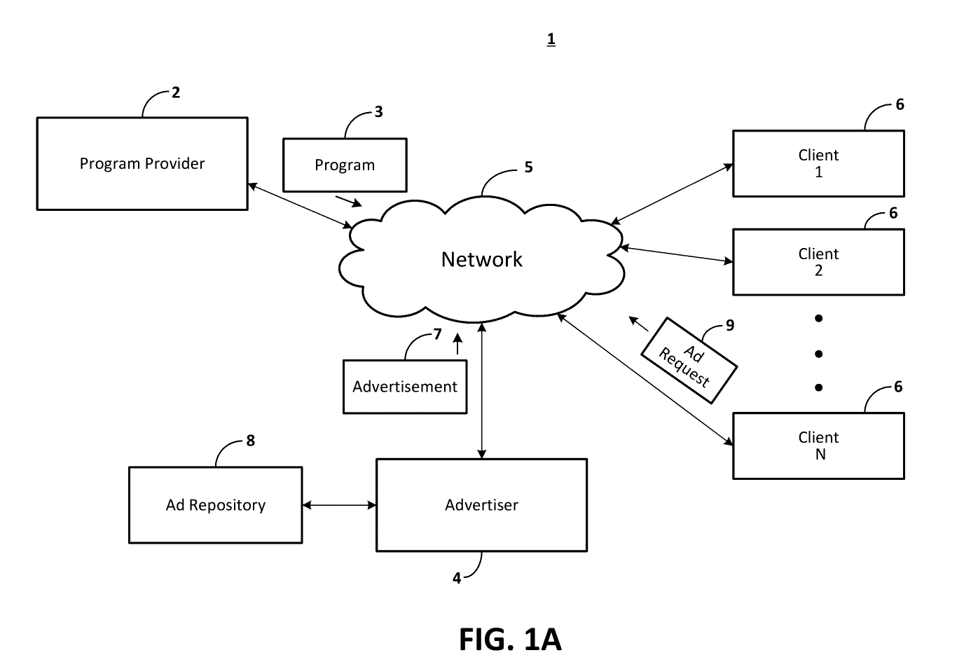

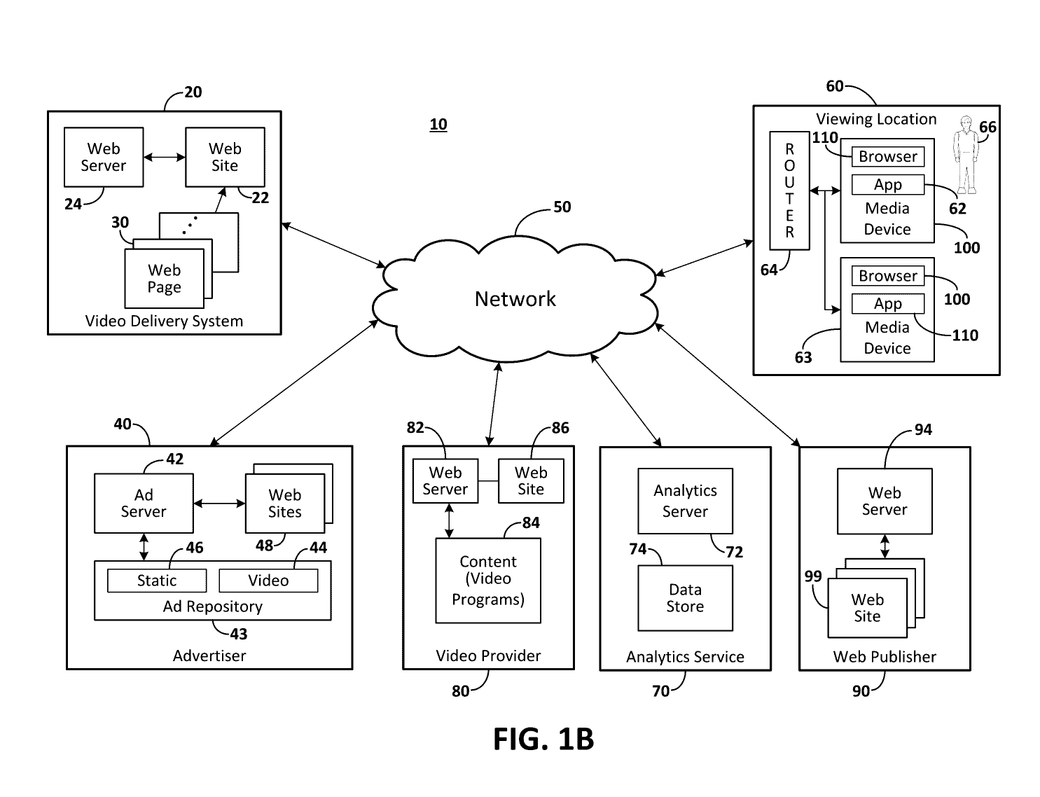

FIG. 1A is a simplified example of an environment in which potential revenue and missed revenue from operation of a media delivery system may be computed and used. In FIG. 1A, environment 1 includes program provider 2, advertiser 4, and clients 6, all of which communicate over network 5. Also included in environment 1 is advertising repository 8. The program provider 2 primarily provides programs 3, the advertiser 4 primarily provides advertisements 7, and the clients 6 primarily receive the programs 3 and the advertisements 7. In an embodiment, the advertiser 4 provides the advertisements 7 to the program provider 2. The program provider 2 then includes the advertisements 7 with the programs 3. In another embodiment, the program provider provides the programs 3, which may include a link to the advertisement 7, and the clients 6 then receive the advertisements 7 from the advertiser 4 using the link. In yet another embodiment, the programs 3 include one or more advertising availabilities, and when the advertisements 7 are displayed at the clients 6, the clients 6 may send an ad request 9 to the advertiser or the program provider 2,

The discussion that follows may refer to the advertisement 7 as advertisements or ads; or, in the singular, as an advertisement or an ad. In an embodiment, the advertisements include video advertisements and static advertisements. However, the advertisements 7 may include other advertisement forms. As noted, the advertiser 4 may provide the advertisements for presentation with the programs 3, such as videos and embedded executables or software, provided by the program provider 2. The program provider 2 may provide a program 3 through the network 5 to one or more clients 6. The advertisements may be distributed through network 5 to one or more clients 6 before, during, or after presentation of the programs 3. The advertiser 4 may be coupled to the advertising repository 8, and may retrieve therefrom advertisements 7 to serve with the programs 3. The clients 6 may be any media devices capable of displaying the programs 3 and the advertisements 7. In an embodiment, an advertisement 7 includes a link to a promoted video program, which may be a video program or video advertisement served on a Web page linked to the search results Web page or a video watch page.

In order to present the programs 3 to a client 6 through the network 5, the program provider 2 may incorporate a Web server, and the programs 3 then may be presented on Web pages written in the Hypertext Markup Language (HTML), or any language suitable for authoring Web pages. The program provider 2 may be an individual, a Web publisher, or another entity capable of distributing content over the network 5. The program provider 2 may make the programs 3 available using a specific address, or URL.

The program provider 2 may receive requests from the clients 6 for programs 3. The program provider 2 may retrieve and then provide the requested programs 3 in response to the request.

The programs 3 may include various forms of electronic media. For example, a program 3 may include text, audio, video, advertisements, configuration parameters, documents, video files published on the Internet, television programs, audio podcasts, video podcasts, live or recorded talk shows, video voicemail, segments of a video conversation, and other distributable content. The programs 3 may include sports, news, weather, entertainment, games, applications, or other content items. The programs 3 may include content such as documents (e.g., Web pages, plain text documents, dynamic network applications provided to the user on-the-fly, Portable Document Format (PDF) documents, images), and video or audio clips. The programs 3 may be graphic-intensive, media-rich data, such as, for example, FLASH-based content that presents video and audio or Asynchronous JavaScript and XML (AJAX) based Web applications or Web pages. The programs 3 may include, for example, a live or recorded television program, a live or recorded theatrical or dramatic work, a music video, a televised event (e.g., a sports event, a political event, and a news event), and an animated feature.

In an embodiment, the advertiser 4, or another entity, may identify which advertisements 7 (e.g., video advertisements and linked promoted video programs) should be served with the programs 3 based, for example, on the subject matter of the programs 3, metadata related to the programs 3, and information related to the clients 6. For example, the advertiser 4 may acquire program information about the subject matter of a program 3, such as by reading program metadata that includes keywords describing the subject matter of the program 3, analyzing audio (e.g., speech) in the program 3, and analyzing the visual content of the program 3, for example. This program information may be obtained in real time or before a search engine executes a search. Alternately, the advertiser 4 may infer the content of a program 3 based on a submitted search query. The advertiser 4 or program provider 2 may obtain information about a client 6 such as, for example, that the client 6 is a smartphone.

A video program also may include many types of metadata. Metadata may include, for example, tags, labels, keywords, time stamps, XML-enclosed data, or other non-displayed information about the content. Metadata may include video data, audio data, closed-caption or subtitle data, a transcript, content descriptions (e.g., title, actor list, genre information, first performance or release date, etc.), related still images, user-supplied or provider-provided tags and ratings. Some metadata, such as a description, may refer to the entire video program, while other metadata (e.g., closed-caption data) may be temporally-based or time coded. Temporally-based data may be used to detect scene or content changes to determine relevant portions of that data for selecting advertisements.

The program provider 2 may provide video programs for presentation at a client 6. The video programs may be presented as a stream or as a downloadable file to a client 6. The program provider 2 also may provide a video player with the video program. In an embodiment, the program provider 2 provides a video program and a video player is embedded in a Web page. The Web page may include the video player and a reference to the video program. The Web page may be sent to the client 6. At the client 6, the embedded video player may receive the referenced video program for playback.

In an embodiment, a resource such as a Web page and a video program embedded in the resource are provided by different program providers. For example, a first program provider may embed (or provide) in a second Web page provided by a second program provider a link to a video at a first Web page. The link is a location (e.g., a URL) of the first Web page. When the second Web page is rendered at the client 6, the video program may be obtained from the second program provider by activating the link.

Some advertisements 7 may have many or all of the characteristics of a video program. Accordingly, a video advertisement may be described by the same physical characteristics used to describe a video program. Other advertisements, as noted above, may contain a thumbnail image, lines of text, and a link to a video advertisement. The description that follows focuses on these later forms of video advertisement.

The program provider 2 may transmit information to the advertiser 4 about how, when, and/or where the video advertisements are to be rendered, and/or information about the results of that rendering such as where the video advertisement appears on a Web page, for example. The program provider 2 also may specify a desired length of a video advertisement. The program provider 2 further may limit a cumulative length of a video advertisement that may be displayed on a Web page and/or may specify a limit on the number of video advertisements that may be displayed. The program provider 2 may impose additional limitations on the physical characteristics of a video advertisement. Finally, the program provider 2 may impose limitations on the content of the video advertisement (e.g., no political video advertisements).

As noted above, video programs and video advertisements may be served on a resource such as a Web page when that Web page is loaded and rendered at a media device such as a lap top computer (i.e., at a client 6). The computer typically has installed thereon a browser, which is a software program that allows the computer to connect to and acquire content (i.e., Web pages) from a Web server. A Web page may display static images, including text, and moving images, including videos and animations. Video programs displayed by way of a Web page may be short, on the order of seconds, to long, such as for a full-length feature film.

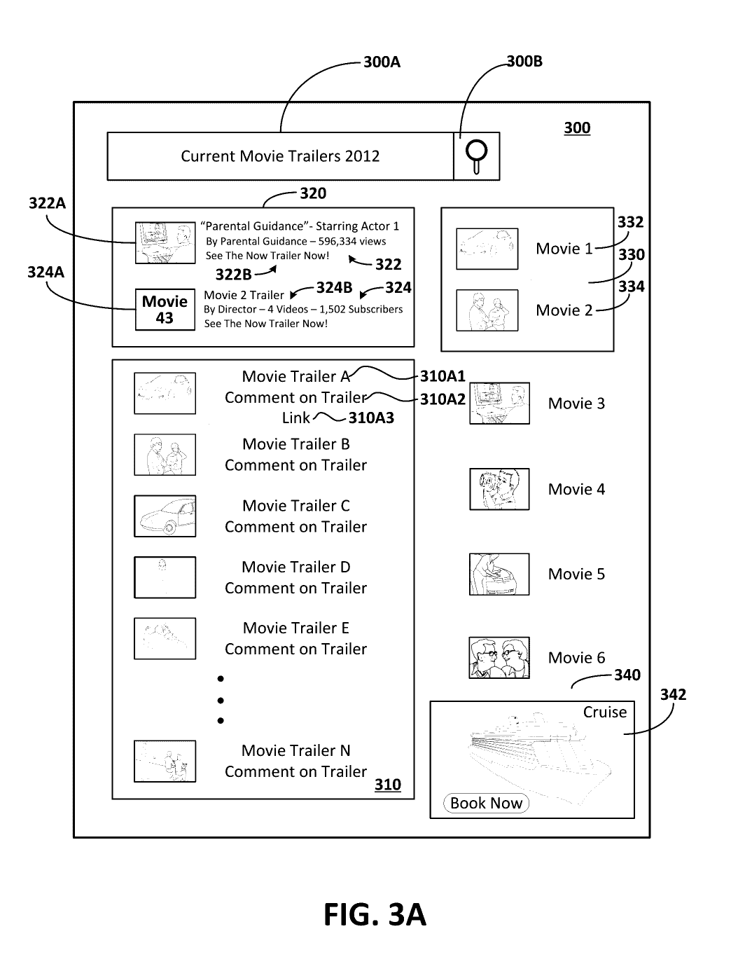

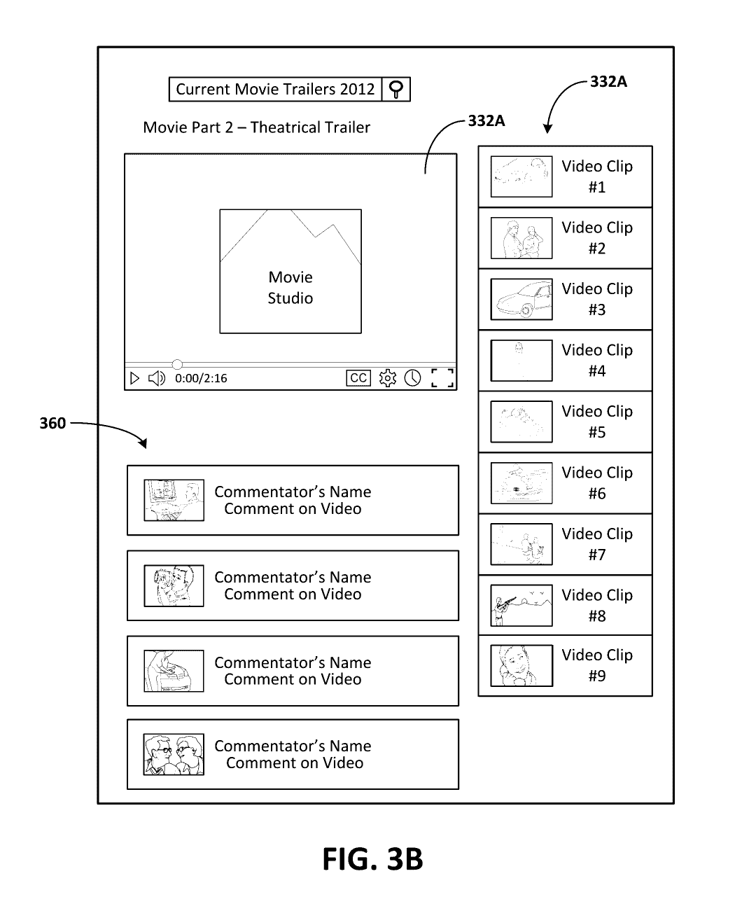

The video programs may be provided on a search results Web page, a video watch page, or a video channel subscription page. In the context of a search, a Web site visitor operating a client 6 submits a search query, for example, “movie trailers 2012” (see, e.g., FIG. 3A), to a search engine, and the search engine returns a number of movie trailers on the search results Web page. When the search results Web page is rendered at the Web site visitor's media device, the displayed movie trailers may be represented by a static image; for example, a first frame or thumbnail of the movie trailer. The Web site visitor then clicks on one of the movie trailers, and the video program begins. In some examples, only the first portion of the movie trailer is buffered in the Web site visitor's media device, and the remaining portions then are streamed to the media device. The search results Web page also may display a number of advertisements. The advertisements may be static (e.g., a banner ad) or video advertisements including video advertisements with linked videos.

Video advertisements may be included in a separate section of the Web page or may be included with a specific video program. For example, a sports video clip may play, but may be preceded by a video advertisement. Some video advertisements auto play, some may auto play, but may be stopped and discarded or skipped after a set time, such as five (5) seconds, and some may require the Web site visitor to click on the video advertisement to initiate play. As noted above, some video advertisements that accompany a video program may play before the video program plays; these may be called pre-roll video advertisements. Other video advertisements play periodically during the course of playing the video programs; in this respect, the video advertisements are akin to commercials shown in broadcast television, and these video advertisements may be called instream video advertisements. Other video advertisements may play at the end of the video program. Some auto play video advertisements begin play when the Web page loads and is rendered. Some video advertisements only play when the Web site visitor clicks on the video advertisement. Other video advertisements may be requested, served, and displayed after an advertising availability is detected on a Web page.

Advertisers providing video advertisements may prefer to pay only for those video advertisements that actually are watched. Thus, when a video advertisement is served on a Web page, but does not play, or has its play stopped by action of the Web site visitor, the advertiser may prefer not to be charged. That is, the advertiser may prefer an advertising basis that is more akin to the cost-per-click (CPC) basis typically used for static advertisements. Correspondingly, a Web site publisher may want to increase revenue by serving video advertisements that are more likely to actually play. Accordingly, both the advertiser and the Web site publisher may want a mechanism to select video advertisements that have a high probability of being played; for example, video advertisements that may be of interest to the Web site visitor.

The disclosure herein focuses on video advertisements as presented on

Internet Web pages. However, similar concepts apply to other forms of online content delivered at other types of online resources. For example, the systems and methods apply to video advertisements served with applications executing on mobile media devices such as tablets and smartphones; video games played on a dedicated fixed or mobile game player, or on a lap top computer, tablet, or smartphone; and other online content and online resources.

In one aspect, the herein disclosed systems and the methods enabled thereby may consider content derived from the linked promoted video program and metadata associated with the promoted video program.

In another aspect, the systems and method may consider the performance of the promoted video program, including the number of unique views and information derived from comments about the promoted video programs such as a “thumbs up/thumbs down” (“like/dislike”) rating, keywords in the comments, number of comments, and click through actions by Web site visitors during or after viewing the promoted video program (e.g., buying movie tickets online, purchasing a DVD of the promoted video program). The performance of the promoted video program also may include programs watched data such as for example: “video watch rate”, “video completion rate”, “video stopped in the middle”, “actions performed after the video”, and “video watched multiple times by the same individual”. These metrics may be used to determine how lucrative an ad format may be for advertisements served with display of the video program. Using this lucrative ad format factor to designate or select an advertisement to be served on a particular Web page may increase the actual revenue received by the program provider.

In yet another aspect, the systems and the methods enabled thereby may use information about how a Web site visitor has interacted with a video program. The interaction information also may be gathered by an analytics service or other third party. This interaction information may be used to provide insight into how interesting a video program is. The interaction information may be derived from a number of metrics, including, for example: “video watch rate”, “video completion rate”, “video stopped in the middle”, “actions performed after the video”, “indicated likes/dislikes,” and “video watched multiple times by the same individual”.

In still another aspect, the herein disclosed systems and methods, in evaluating and selecting a video advertisement, may take into account the specific type, make, and/or model of media device on which the Web page will be rendered and the video program and advertisement displayed. For example, the systems may detect that a media device is a smartphone as opposed to a tablet or an iTV. Some advertisements may not be effective when displayed on a smartphone. Some video advertisements, because of their length, contrast, or audio may best be displayed on a fixed media device such as an iTV in an indoor setting. Thus, an advertiser, Web site operator, or video program provider may prefer not to have certain advertisements served on a Web page rendered on a roaming smartphone, for example.

The methods executed by the herein disclosed systems may involve use of information that in some respect identifies a device the Web site visitor uses to access the video programs. For example, when a Web site visitor uses an Internet browser to access a Web site, a Web server may create a random identification (ID) that identifies the browser and may cause the random ID to be stored on the Web site visitor's device.

In situations in which the systems disclosed herein collect personal information about Web site visitors, or may make use of personal information, the Web site visitors may be provided with an opportunity to control whether programs or features collect Web site visitor information (e.g., information about a Web site visitor's social network, social actions or activities, profession, a Web site visitor's preferences, or a Web site visitor's current location), or to control whether and/or how to receive advertisements from an ad server that may be more relevant or of interest to the Web site visitor. In addition, certain data may be treated in one or more ways before it is stored or used, so that personally identifiable information is removed. For example, a Web site visitor's identity may be treated so that no personally identifiable information can be determined for the Web site visitor, or a Web site visitor's geographic location may be generalized where location information is obtained (such as to a city, ZIP code, or state level), so that a particular location of a Web site visitor cannot be determined. Thus, the Web site visitor controls how information is collected about the Web site visitor and used by a server.

FIG. 1B illustrates a more detailed view of an environment similar to that of FIG. 1A, and in particular illustrates aspects of an environment in which potential revenue and missed revenue from media delivery may be computed and used. In FIG. 1B, environment 10 includes video delivery system 20, advertiser 40, viewing location 60, analytics service 70, video provider 80, and Web site publisher 90, all of which communicate over network 50. Although FIG. 1B shows these entities as separate and apart, at least some of the entities may be combined or related. For example, the video delivery system 20 and analytics service 70 may be part of a single entity. Other combinations of entities are possible.

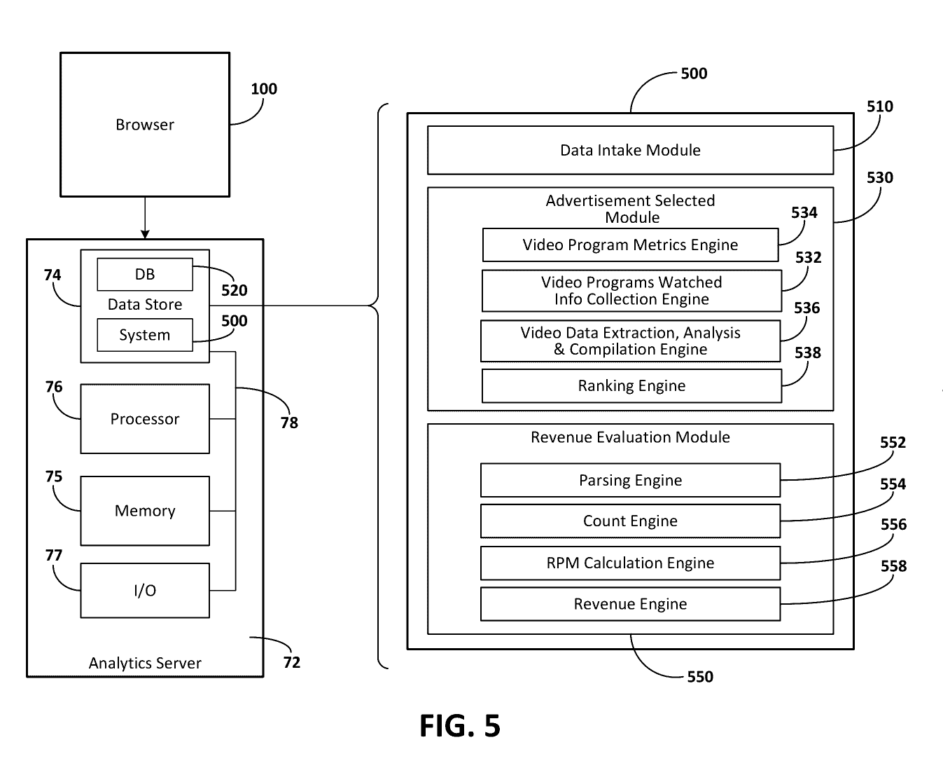

The video delivery system 20 operates Web site 22. The Web site 22 is hosted on Web server 24. The Web site 22 includes Web pages 30. The Web site 22 may include Internet search features that allow Web site visitors 66 to search for video programs and other content displayed by the Web server 24 on the Web pages 30. The Web pages 30 may display search results, namely programs such as video programs, as well as video advertisements, static advertisements, and other information. Some advertisements may provide links to other Web pages where video advertisements are displayed. The Web server 24 may provide links to enable navigation among the Web pages 30. The Web site 22 may display video advertisements created and provided by advertiser 40, and video programs created by Web site visitor 66, video provider 80, and other entities. The Web server 24 may incorporate components of a video advertisement selection system in which potential advertisement revenue and missed advertisement revenue may be computed and used. Example components of the video advertisement selection system are described with respect to FIG. 5. As an alternative to implementation on the Web server 24, at least some components of the video advertisement selection system may be implemented at another back-end server such as at the analytics service 70.

The Web pages 30 may display search results in response to a search query submitted by Web site visitor 66. For example, a Web page 30 may display several video programs that satisfy a search query. Each such video program may be assigned a unique identification (ID). The Web pages 30 also may display one or more static or video advertisements. The Web site visitor 66 may be more interested in the displayed advertisements when the displayed advertisements have some relationship to the content of the video programs appearing on the Web page 30. One aspect of selecting a video advertisement may be to match content and associated data, information, and metadata derived from the video advertisement with keywords that relate to the content of the video programs appearing on the Web page 30. Thus, serving video advertisements on a video Web page 30 may be improved when the video advertisements are served based on the content of the video programs appearing on the Web page 30. For example, video advertisements for polar bear tours in Churchill, Manitoba may be more appropriate when served with search result video programs about Arctic life than for search result video programs about the Amazon.

The advertiser 40 operates ad server 42 to provide video advertisements 44 and static advertisements 46 that are served at the Web pages 30, and that may be stored in ad repository 43. A video advertisement 44 may link to a promoted video program, which also may be stored in the ad repository 43 along with a promoted video program ID and associated data, metadata and information. In an embodiment, the ad repository 43 stores only current video advertisements.

The advertiser 40 may be or may represent a single company or entity, a group of related companies, or a group of unrelated companies (e.g., the advertiser 40 may operate as an ad broker). In an embodiment, the advertiser 40 may operate an online advertising network. In an embodiment, the advertiser 40 and the video delivery system 20 are part of the same entity. The advertiser 40 may operate the ad server 42 to provide one or more Web sites 48. The video advertisements 44 may include audio, video, and animation features. The video advertisements 44 may be in a rich media format. In one aspect, the video advertisements 44 are linked to promoted video programs displayed at the Web sites 48.

The video advertisements 44 may include links to other Web pages and other Web sites, including the Web sites 48. For example, a video advertisement 44 for a car may be represented on Web page 30 as a thumbnail image, text, and a link to a car manufacturer's Web site. A Web site visitor 66 viewing the thumbnail image at the Web page 30 may click on the advertisement 44 and be redirected to the car manufacturer's Web site 48 where a video advertisement of the manufacturer's car is played.

The network 50 may be any communications network that allows the transmission of signals, media, messages, voice, and data among the entities shown in FIG. 1B, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless. The network 50 may be all or a portion of an enterprise or secured network. In an example, the network 50 may be a virtual private network (VPN) between the video delivery system 20 and a media device at the viewing location 60 across a wire line or a wireless link. While illustrated as a single or continuous network, the network 50 may be divided logically into various sub-nets or virtual networks, so long as at least a portion of the network 50 may facilitate communications among the entities of FIG. 1 B.

The viewing location 60 may be the residence of an individual, such as Web site visitor 66, who operates media devices 62 and 63 to access, through router 64, resources such as the Web sites 22. The viewing location 60 may be a mobile location that changes with time as, for example, when the Web site visitor 66 changes his location. The media devices 62 and 63 may be fixed or mobile. For example, media device 62 may be an Internet connected smart television (iTV) (e.g., a television incorporating a processor and a browser); a basic or smart television connected to a set top box (STB) or other Internet-enabled device; a Blu-ray™ player; a game box; and a radio, for example. Media device 63 may be a tablet, a smartphone, a lap top computer, or a desk top computer, for example. The media devices 62 and 63 may include browsers, such as browser 100. The browser 100 may be a software application for retrieving, presenting, and traversing resources such as at the Web site 22. A resource may be identified by a Uniform Resource Locator (URL) and may be a Web page, image, video, or other content. The URL may allow the browser 100 to connect to the Web site 22. Hyperlinks present in resources enable the Web site visitor 66 to navigate the browser 100 to related resources. The Web site visitor 66 may operate the browser 100 to search for Web sites related to specific topics or to search for a specific Web site by URL. The media devices 62 and 63 also may include applications 110. The Web site visitor 66 may cause the media devices 62 or 63 to execute an application 110, such as a mobile banking application, to access online banking services. The application 110 may involve use of a browser or other means, including cellular means, to connect to the online banking services. Other applications may include game applications. The game applications may include provisions for serving video advertisements during the play of the game. Once connected to the Web site 22, the media devices 62 and 63 may allow viewing of content such as video programs and static images generated by entities such as the video provider 80 and displayed on the Web pages 30 at the Web site 22. The video programs and static images may include slots or spaces into which programs such as advertisements may be placed. When such a video program or static image is to be viewed on the media devices 62 or 63, the browser 100 may send an advertisement (ad) request, which is received at the advertiser 40, and which may be answered with a video advertisement 44 and a static advertisement 46.

The Web site visitor 66 may access the Web site publisher 90 to use a social networking Web site, a blog Web site, including a personal blog Web site and/or a commercial blog Web site, and other Web sites.

The Web site visitor 66 may operate the media devices 62 and 63 to communicate through the network 50 directly to the analytics service 70. For example, an application on the media device 62 may be a game. The individual game moves (clicks) made by the Web site visitor 66 in playing the game may be sent directly to the analytics service 70 by the media device 62. For example, when paying a video word game (i.e., application 110), the Web site visitor may type in a word based on a set of available letters and “hit” an “enter” button. In response, the application 110 may send an ad request to the ad server 42. The ad server 42 may respond by sending a video advertisement to the media device 62. If the Web site visitor 66 elects to view the video advertisement, the browser 100 in the media device 62 may send an advertisement played signal directly to the analytics service 70. Alternately, the advertisement played signal may be sent to the ad server 42, and the ad server 42 sends a corresponding signal to the analytics service 70.

The analytics service 70 includes analytics server 72. The analytics service 70 may operate in conjunction with Web site operators to collect, analyze, and report information and data related to visits to Web sites and viewing of video advertisements by Web site visitors 66. The analytics service 70 may be part of the video delivery system 20, or the advertiser 40, or may be a separate entity. The analytics service 70 collects, analyzes, stores (in data store 74), and reports on data and information related to visits to the Web site 22, operation of applications, and other reported activity. In an embodiment, as is described with respect to FIG. 5, the analytics service 70 may operate system 500 to collect video program information, video advertisements watched information, and other information that may be used to improve serving of video advertisements in the video delivery system 20 or at a Web site operated by Web site publisher 90.

In an embodiment, given the potentially large number of video advertisements, video programs, search engines, and Web pages, the analytics service 70, and particularly the analytics server 72 and its associated data store 74 may be replicated such the analytics service 70 includes hundreds or thousands of such server-data store combinations in a distributed architecture that makes the analytics service 70 responsive to a very large number of video program search requests per unit time.

The video provider 80 provides content, in the form of video programs 84, which may be displayed on the Web pages 30 and viewed and/or heard by the Web site visitor 66 using the media devices 62 and 63. In an embodiment, the video provider 80 operates, using Web server 82, video sharing Web site 86, and may embed the videos 84 on the Web site 86. However, the video provider 80 may simply create and provide video programs, such as polar bear video programs, for display by other entities such as the video delivery system 20 or at a Web site operated by Web site publisher 90. The video provider 80 may be a company, a movie or television studio, or an individual.

The Web site publisher 90 operates Web sites 99 using Web server 94. The Web sites 99 may include those on which Web site visitors 66 may provide comments, upload videos, and upload images. The Web sites 99 may include social networking Web sites. The Web site publisher 90 may operate a Web hosting service, and the Web sites 99 may be personalized for and used by individuals, such as the Web site visitors 66.

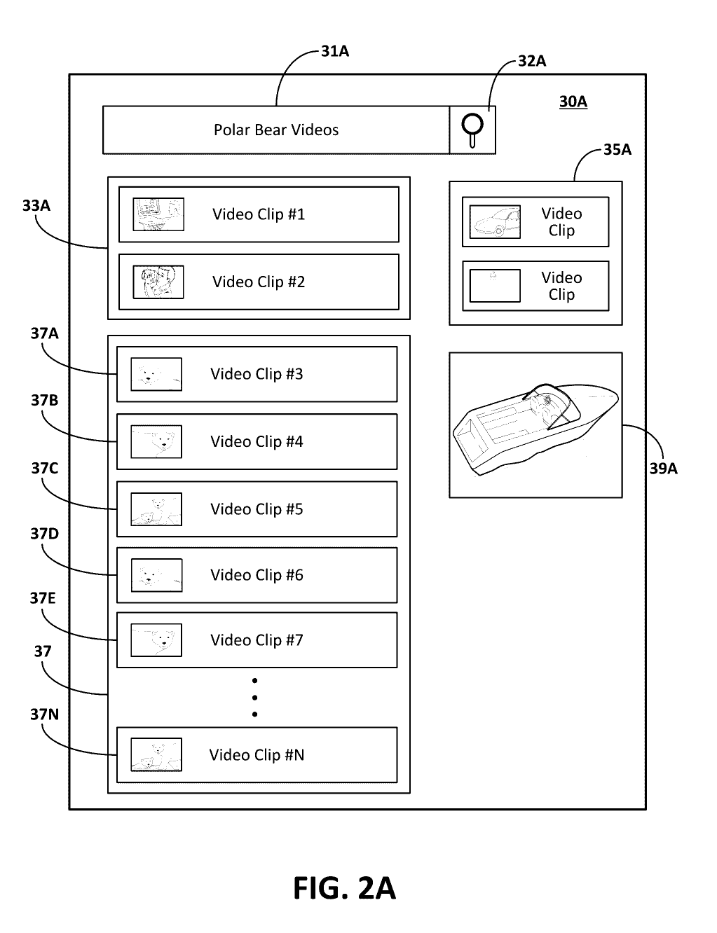

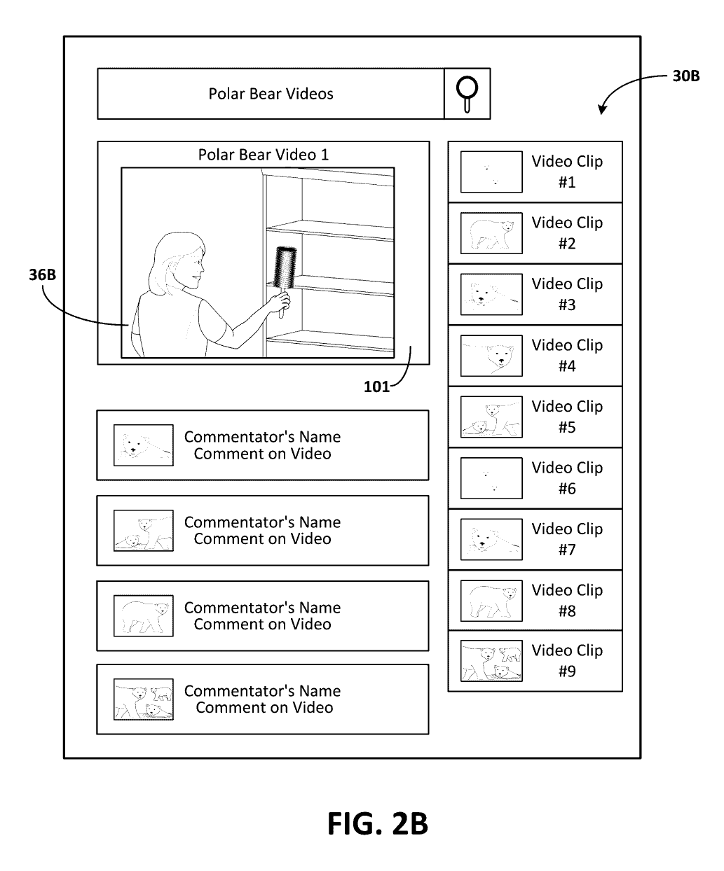

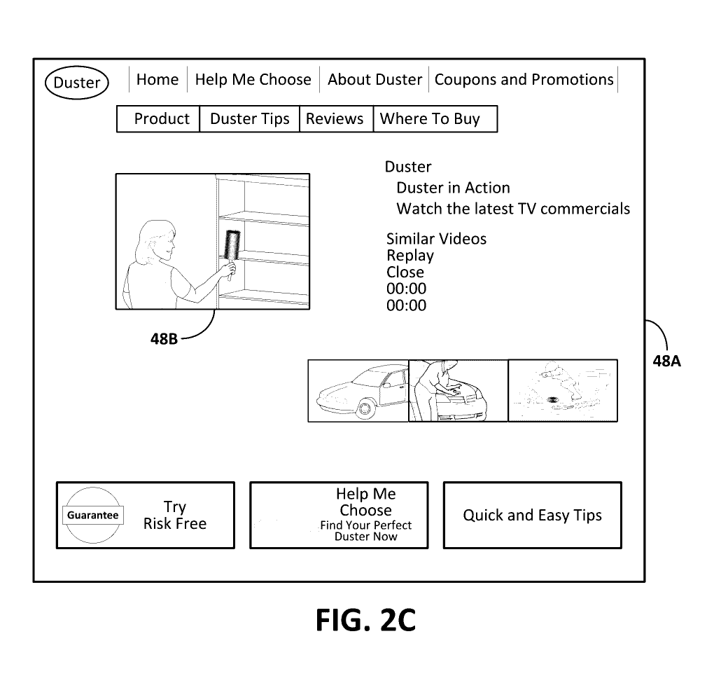

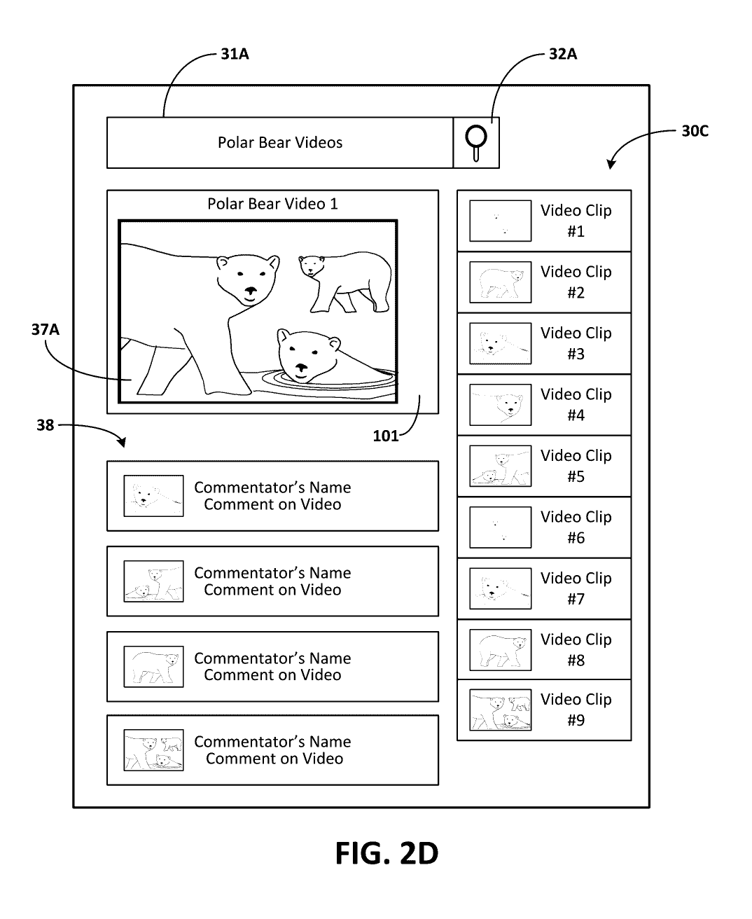

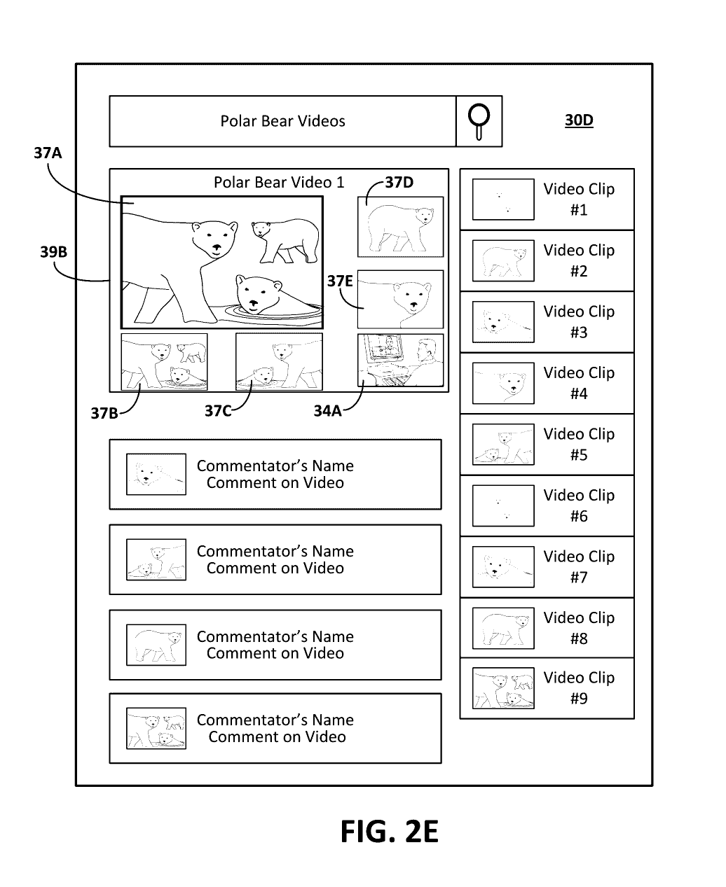

FIGS. 2A-2E illustrate examples of Web pages on which video programs may be displayed and on which may be served video advertisements or links to video advertisements.

FIG. 2A illustrates an example Web page displaying results of a search query for polar bear video programs. In FIG. 2A, Web page 30A includes search query window 31A in which Web site visitor 66 has entered a search query for polar bear videos. The Web site visitor 66 initiates the search by pressing search button 32A, which has a magnifying glass icon. A search engine returns polar bear video programs 37A-N in video program area 37. The Web site visitor 66 may select a video program 37n to begin play by clicking on the video program thumbnail. The video program then will load from the video delivery system 20 and begin play. However, the video program may load in groups of frames (i.e., the video program sections are buffered in the browser 100).

The Web page 30A shows three advertisement areas. Advertisement area 33A is displayed at the top of the Web page 30A above the video programs 37n, and includes two video advertisements. Advertisement area 35A also is at the top of the Web page 30A and also includes two video advertisements. Advertisement area 39A provides a static advertisement. Other arrangements of advertising areas are possible.

When the Web site visitor 66 clicks on one of the video programs 37n, rather than the selected video program beginning to play, the browser 100 may send an ad request for a video advertisement, and a pre-roll video advertisement may be displayed in a video player (not shown). Alternately, an overlay ad may be displayed for a limited time such as 30 seconds and then may disappear. In yet another alternative, an instream video advertisement may be displayed in the video player, and display of the selected video program may be suspended until the instream video advertisement completes play or is skipped by the Web site visitor 66.

Many other combinations of advertisement displays are possible. In an embodiment, one advertisement, or a subset of available advertisements may, when served in conjunction with the display of the selected video, be most lucrative in the sense of generating higher revenue for the video delivery system 20. Which advertisement or subset of available advertisements is most lucrative may depend on several factors including ad format, the type of media device, and demographic data related to the Web site visitor 66. For example, the Web site visitor 66 may have registered with a video delivery service provided by the video delivery system 20 and may have declared certain demographics (e.g., age, gender). In subsequent accesses to the video delivery service, processors in the Web server 24 may recognize the Web site visitor 66 and may use the declared demographics as part of a signal used by the advertisement selection system 500 (see FIG. 5) to select advertisements on Web page 30A.

The advertisements represented in the areas 33A, 35A and 39A all may include links to other Web sites and other Web pages, and when the Web site visitor 66 clicks on any of these advertisements, the Web site visitor's browser 100 may be directed to the appropriate linked Web page where the advertisement (video or static) is displayed.

FIG. 2B illustrates Web page 30B, which is displayed in video player 101 as a result of the Web site visitor 66 clicking on the first polar bear video program 37A. However, rather than immediately playing the polar bear video program 37A, the video player 101 plays video advertisement 36B for a duster (e.g., the Web site visitor 66 has declared demographics to include housewife for occupation). In an alternative, the video advertisement 36B plays to completion (e.g., 20 seconds) before the polar bear video program begins playing. In another alternative, the Web site visitor 66 is able to skip all or part of the advertisement 36B.

FIG. 2C illustrates an example Web page (as shown, a duster product home page) to which the Web site visitor 66 is directed upon clicking on the advertisement 36B of FIG. 2B. In FIG. 2C, Web page 48A displays promoted video program 48B for the same duster product as in the video advertisement 36B, and in addition displays links to other Web pages providing product information, offers, product reviews, related products, and store locations.

FIG. 2D illustrates example Web page 30C showing polar bear video 37A in mid-play. As can be seen, in addition to the polar bear video, Web page 30C also includes a comments section 38 in which Web site visitors 66 may comment on the video 37A, other videos, or other subjects. When the polar bear video 37A is paused in the video player 101, an instream advertisement may play.

FIG. 2E illustrates example web page 30D, which includes video viewing area 39B. Viewing area 39B shows a thumbnail of the featured polar bear video 37A, and thumbnails of other polar bear videos as well as a thumbnail for a video advertisement 34A.

FIGS. 3A and 3B illustrate further example online resources at which are served video content segments.

FIG. 3A illustrates an example search results Web page on which are displayed search results for a query for movie trailers. In FIG. 3A, Web page 300 includes search query window 300A in which a Web site visitor 66 may enter a search query. In the example of FIG. 3A, the visitor 66 has entered “current movie trailers 2012” as the search query. Search button 300B, which shows a magnifying glass icon, is used to initiate execution of the search. The Web page 300 includes search results area 310 in which are displayed, as search results, movie trailers 310A-310N. Each movie trailer includes additional data, or metadata, such as a title 310x1 (x is a variable having the values A-N), number of views 310x2, and a link 310x3. Activating the link 310x3 may cause the browser 100 to navigate away from the Web page 30B to another Web page connected to the link.

The example Web page 300 includes three ad sections. A first ad section 320, which is displayed at a prominent (i.e., top) part of the Web page 300, includes two video advertisements. The two video advertisements illustrated also are for movie trailers. The video advertisements may be represented by a thumbnail image and associated metadata. Thus, movie trailer 322 and its associated thumbnail 322A and metadata 322B is a first video advertisement, and movie trailer 324 and its thumbnail 324A and metadata 324B is a second video advertisement. The metadata associated with these advertisements may include a movie title, the current number of views, and a link, “See Trailer Now”. In another embodiment, the metadata may provide a link to see further information including additional trailers for the movies. Finally, a video advertisement may include a link that, when clicked on by the Web site visitor 66, will cause the browser 100 to navigate to a Web page that displays the movie trailer.

A second ad section 330 includes additional video advertisements, also for movies, including video advertisements 332 and 334. The video advertisements 332 and 334 have features similar to those of the video advertisements in the first ad section 320.

Finally, ad section 340 displays static advertisement 342. The static advertisement 342 includes a link (Book Now) to a separate Web page (e.g., such as Web page 48) for the advertised product.

FIG. 3B illustrates Web page 350, which displays a video advertisement 332A associated with video advertisement 332 of FIG. 3A. Also included on Web page 350 is a comments/blog section 360 in which Web site visitors 66 may post comments about the video advertisement 332A, rate the video advertisement 332A, discuss the movie associated with the video advertisement 332A, and provide comments in response to comments of other Web site visitors 66.

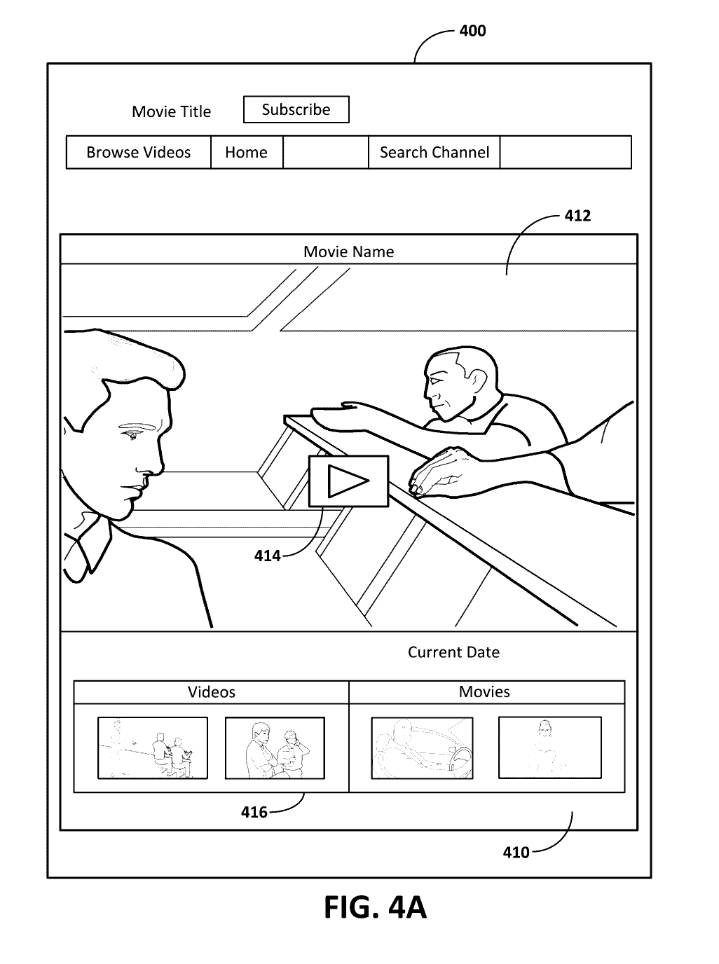

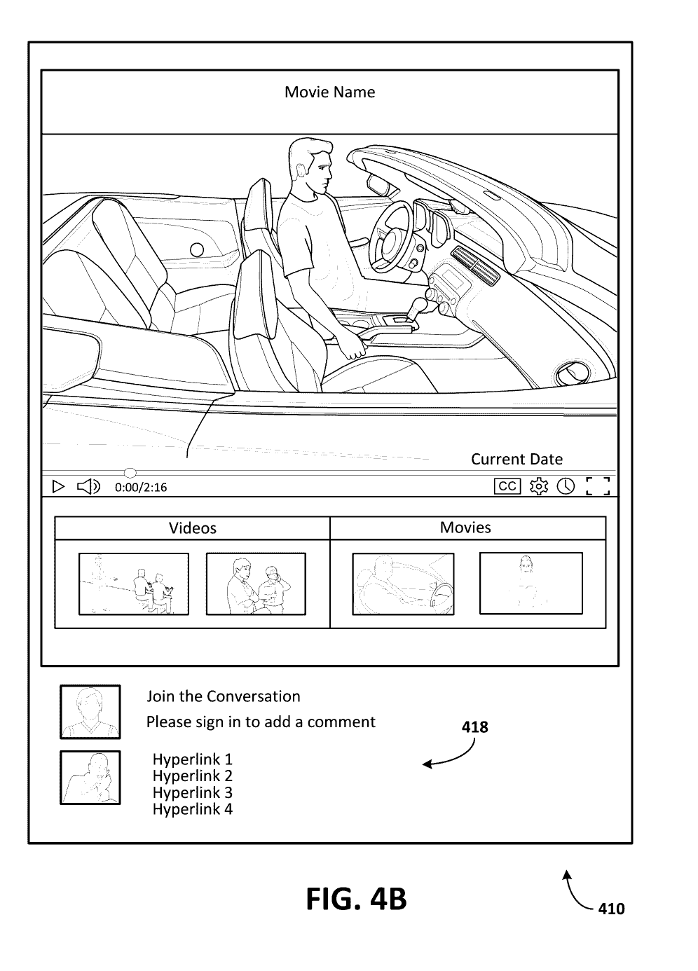

FIGS. 4A and 4B are still further example online resources at which are served video content segments.

FIG. 4A illustrates Web site 400, which is a Web site for one of the movie trailers shown in ad section 320 of FIG. 3A, and Web page 410, displayed at the Web site 400. The Web page 410 displays thumbnail image 412, which is a first frame of the movie trailer, start/pause button 414, which is used to start and pause the movie trailer, and related information section 416, which may show stills from the movie and other information.

FIG. 4B illustrates Web page 410 after the play button 414 has been pressed and the movie trailer begins playing. As can be seen, the Web page 410 includes comment section 418 in which other Web site visitors may post comments about the trailer, the movie itself, and other matters.

FIG. 5 is a block diagram of an example video advertisement selection system for determining potential and missed revenue from advertisements served with video programs in a video delivery system. FIG. 5 shows video advertisement selection system 500, which, in this example, is implemented on analytics server 72. The analytics server 72 includes data store 74 that stores the program code of system 500. However, as noted above, the video advertisement selection system 500 may be implemented on other entities of the environment 10 shown in FIG. 1B, including being distributed among multiple entities. Furthermore, the environment 10 of FIG. 1B shows a single analytics server 72 and a single data store; however, the system 500 may be implemented on multiple servers which may access multiple data stores in a distributed and highly scalable architecture. Some data in the distributed data stores may be replicated among the multiple data stores. The data store 74 is a non-transitory computer readable storage medium. Processor 76 accesses the data store 74 to load into memory 75 and execute the program code of the system 500. The data store 74 also may include actual video content for the video advertisements, and corresponding metadata and video watched data for the video advertisements. The data store 74, memory 75, processor 76, as well as input/output (I/O) 77 are coupled by data and communication bus 78. In an embodiment, the data store 74 retains this video content, metadata, and video watched data for active video advertisements; i.e., for video advertisements that advertisers indicate to the analytics service 70 are still to be served. Alternately, the actual content of the video advertisement is maintained by the advertiser 40 in the advertisement repository 43. With either alternative, the analytics service 70 may maintain the metadata and video watched data up-to-date for these active video advertisements.

The analytics server 72 receives an input related to video programs watched (the video watched data). The input to, processing of, and output from, the analytics server 72 is described below.

The advertisement selection system 500 includes data intake module 510, database 520, which may reside in data store 74, advertisement selection module 530, and revenue evaluation module 550. The data intake module 510 receives inputs such as programs watched data, ad requests, declared demographics data, advertisement identifications (IDs), and processed data from program instructions executed on the processor 76. The data intake module 510 may store the processed data in the database 520.

The advertisement selection module 530 includes video programs watched information collection engine 532, video program metrics engine 534, video data extraction, analysis and compilation engine 536, and ranking engine 538. The engine 532 receives video program watched information collected by and sent from the browser 100. The engine 532 receives video program watched information collected by and sent from the browser 100 or another device at the viewing location 60. The engine 532 may correlate the information with an identification (ID) of a video advertisement (i.e., a video advertisement ID). The engine 532 may store the video program watched information in the database 520, along with the appropriate, unique video advertisement ID. The engine 532 may update the stored information in the database 520 as more video program watched information is received from the browser 100. The engine 532 may process some of the received information prior to storage. For example, the engine 532 may average newly received information with that currently stored in the database 500, and then store the newly averaged values in the database 500.

The video program metrics engine 534 performs further processing and computations on the data stored in the database 500. For example, the metrics engine 534 may compare values received from the browser 100 for a length of time a video advertisement was watched and compare this length to a threshold to determine if the video advertisement should be included as a viewed video advertisement. As a further example, a video advertisement that is watched for half its actual length may be counted as a viewed video advertisement. In another example, the rendering of the video advertisement, or any part of the video advertisement, on the Web page may qualify the video advertisement as viewed. The engine 534 also may apply weights to one or more of the collected video advertisement metrics. The weights may be provided by a Web site publisher or video program provider, for example. The weights may be adjusted over time to optimize the weightings. For example, weights may be determined from experimentation and empirical analysis of performance of video advertisements placed using different weights. As another example, a machine learning process may be used to analyze the video advertisement performance and adjust weights without manual intervention.

The video data extraction, analysis and compilation engine 536 extracts information from the video programs, such as keywords (which may appear in the title of the video program, or which may be extracted by speech recognition software, for example), and other data that may be extracted by machine, such as facial recognition of human video actors, and other machine-recognition of animate and inanimate objects, and scene recognition processes. The engine 536 also may extract information (including, for example, key words) from metadata associated with the video programs. The extraction engine 536 may employ various techniques for extracting the content including, for example, machine learning models, and semantic and/or statistical based algorithms. The engine 536 may extract keywords and may assign weighted values to each keyword.

The data produced by the extraction engine 536 may be used in several aspects. In a first aspect, the data may be used to match video advertisements to video advertisement availabilities based on common keywords between the video program and a video ad request (for example, by reference to a search query term such as polar bear videos). In a second aspect, the data may be used to rank video advertisements through the use of content factors derived from the data. The use of data for these two aspects is described below.

In an alternative, the producer (advertiser 40) of the video advertisement may supply the analytics service 70 with the data and information, such as a list of keywords, the producer desires to use in characterizing the content and physical characteristics of the video advertisement.

The video program may be retrieved by the analytics service 70 from the video delivery system 20 and analyzed by the engine 538. One or more topics or concepts to which the video program is relevant may be determined from the analysis. The content of a video advertisement then is compared to the topics or concepts of the video program. The topics and concepts may be expressed in keywords. For example, topical keywords of a video program may be compared to topical keywords of a video advertisement using, for example, keyword detection and analysis, and a score may be determined from the comparison. If the score exceeds a threshold, for example, the video advertisement may be identified as a candidate for an auction to select video advertisements to serve on the search results Web page 30.

In an embodiment, topical keywords for a video program may be determined using search engine data. For example, data related to interactions to a video program by Web site visitors 66 who were directed to the video program by a search query may be an indication of whether the search query is a good topical keyword for the video program. Interactions with the video program may include watching the video program in its entirety, watching the video program repeatedly, fast-forwarding or advancing the video program, or skipping the video program. A search engine may collect the query and interaction data anonymously and the advertiser 40 or analytics service 70 may analyze the data to determine if a search query is a good keyword for the video program. For example, on the one hand, if Web site visitors 66 who accessed a video program through a search query tended to skip the video program, then the search query may be determined to be a poor keyword for the video program. On the other hand, if the Web site visitors 66 tended to watch the video program, or to watch the video program repeatedly (during one or multiple Web site visits), the search query may be determined to be a good keyword for the video program. Good keywords may be associated with the video program and may be compared to the keywords for the associated video advertisements.

The ranking engine 538 determines if a video advertisement is suitable for an advertising availability in a video program request based, for example, on analysis of keywords derived from a video program search request and, optionally, the video ad request on the one hand, and keywords provided by the advertiser 40, or keywords extracted by the engine 536 for the video advertisement on the other hand. That is, the module 538 identifies candidate video advertisements from a pool of available, active video advertisements (i.e., those stored in data store 74 or referenced in the data store by advertisement ID) to serve in response to an ad request such as may be generated when a search results Web page 30 is rendered in a browser 100 of media device 62. One criterion for identifying candidate video advertisements may be the search query term itself. Another criterion for identifying candidate video advertisements may be the content (e.g., subject matter) of video programs to be displayed on the search results Web page 30. The video programs may have associated metadata specifying one or more topics or concepts. Another criterion may be the overall content of the search results Web page 30 itself. Yet another criterion may be topical or concept information for the video advertisement.

The ranking engine 538 receives bids from various advertisers 40 for video advertisement availabilities and ranks the bids according to how lucrative they may be considering the factors enumerated in the ad request. For example, an ad request may specify a video ad for ad format, and demographics of female. The ranking engine 538 then ranks bids for video advertisements with an expressed demographic of females.

The revenue evaluation module 550 includes parsing engine 552, count engine 554, RPM calculation engine 556, and revenue engine 558. One or more of these engines communicates with the engines of the data intake module 510 and the advertisement selection module 530 to execute a revenue evaluation process.

The parsing engine 552 separates ad requests, received as a result of a display of a video program having an advertising availability on a video watch page or search result page, into its separate factors. The separate factors include gender, country, and ad format, for example. Additional factors may exist for a received ad request.

The count engine 554 counts a number of times a video program was viewed and an ad request was received. The count may be limited on a temporal basis to day part, day, week, month, year, a particular day, or any other temporal basis. Each such ad request received with respect to viewing a video program may be considered a monetizable view.

The RPM calculation engine 556 computes an estimate of the revenue that may accrue. In an embodiment, the estimate may be expressed as revenue per 1000 monetizable views. The RPM may be estimated using historical data.

The revenue engine 558 computes the potential revenue for all monetizable views under the assumption that a most lucrative ad format was requested in the ad request. For example, an ad request might specify an instream video advertisement when a pre-roll video advertisement is known to generate more revenue. This intermediate product generated by the revenue engine 558 may be used to compare actual revenue received for a specific monetizable view to potential revenue that could have been reviewed. The revenue engine 558 then may sum the values of the intermediate products according to one or more of the factors (gender, country) to produce the total potential revenue of an advertising availability appearing in a video watch page or search results page. This total potential revenue value may be compared to the total actual revenue value to indicate where the potential exists to grow revenue. That is, the video delivery system operator may be able to determine in what vertical, in what country, and with what gender it should focus its advertising efforts.

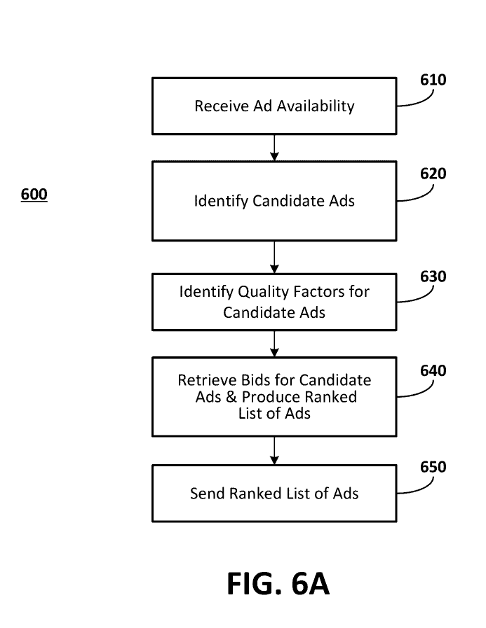

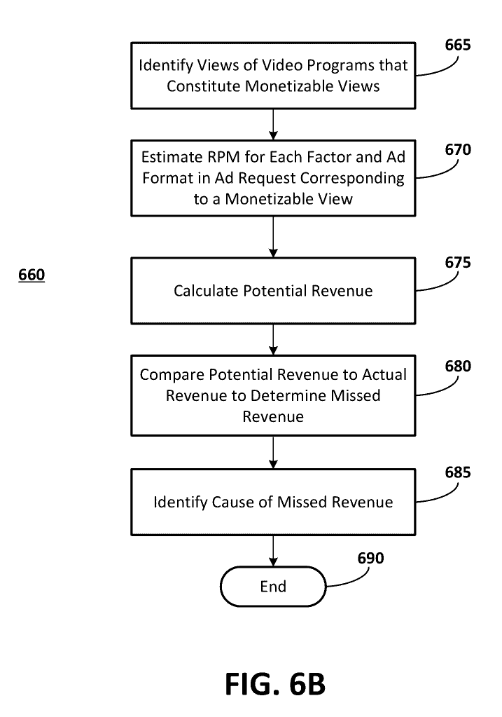

FIGS. 6A-8 are flowcharts illustrating example processes for determining potential and missed revenue resulting from serving video content segments at online resources. The processes shown in FIGS. 6A-8 are based on the environments of FIGS. 1A and 1B, the online resources of FIGS. 2A-4B, and the system 500 of FIG. 5.

In FIG. 6A, process 600 begins in block 610 when ad server 42 receives an advertisement availability (e.g., through an ad request) from the video delivery system 20 for an advertisement to display on Web page 30. The advertisement availability may include one or more keywords that may be used to select an appropriate advertisement. For example, the ad request may include keywords from a search term submitted by a Web site visitor 66. In block 620, the ad server 42 identifies advertisements that match the keywords provided with the advertisement request to establish a first set of candidate video advertisements. In block 630, ad server 42 identifies, where possible, a set of factors i=1−n (e.g., country, vertical, demographics) for each of the advertisements in the first set of candidate advertisements. In block 640, the ad server 42 retrieves bid information for each of the advertisements and applies the bid information to produce a ranked list of advertisements. In block 650, the ad server 42 sends information for advertisements, including the ranked list of advertisements, to fulfill the ad request to the Web server 24. Alternately, in block 650, the ad server 42 selects as many advertisements as necessary to satisfy the ad request, and sends the selected advertisements to the Web server 24. The process 600 then ends.

FIG. 6B is a flowchart illustrating an example method for determining potential revenue related to advertising availabilities in video programs. In FIG. 6B, method 660 begins in block 665 when the system 500 identifies views of video programs that constitute monetizable views. In an embodiment, a monetizable view is a display of a video program that results in the generation of an ad request. In block 670, the system 500 estimates revenue per thousand impressions for each factor and ad format in the ad requests. In block 675, the system 500 calculates the potential revenue for the views. In block 680, the system 500 compares the potential revenue to actual revenue to determine missed revenue. Actual revenue may be computed by the system 500 or may be computed by a separate entity and provided to the system 500. In block 685, the system 500 may be used to identify the causes of any missed revenue. For example, the system 500 may report that although an advertising availability existed in the video program, no ad request was submitted. In block 690, method 660 ends.

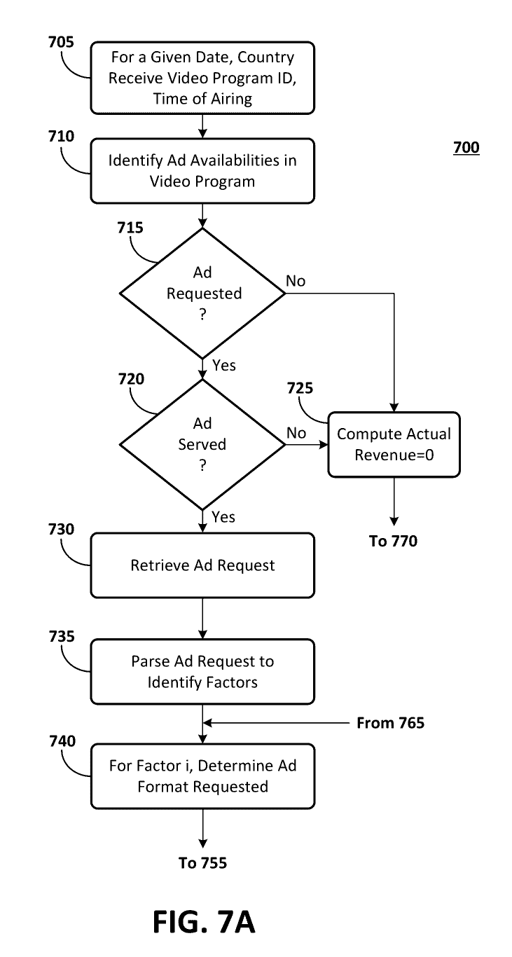

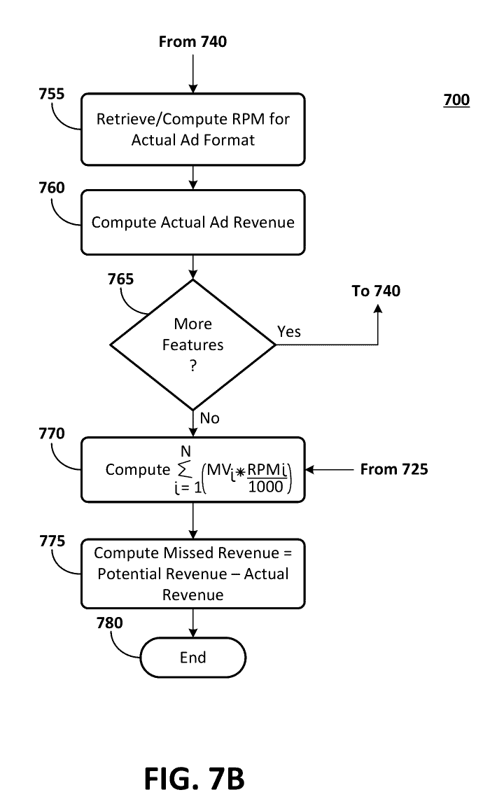

FIGS. 7A and 7B are flowcharts illustrating an alternate example method for computing potential revenue and missed revenue (if applicable) based on advertising availabilities in a video program. In FIG. 7A, method 700 begins in block 705 when the system 500 receives an identification of the advertising availability received in block 610 of FIG. 6A. The identification includes date, time of airing, country, and video program ID. In block 710, the system 500 determines if an advertisement was served in the advertising availability. For example, the system 500 may query the Web server 24 or the ad server 42 for this data. Alternately, the system 500 may record information related to all video program accesses, advertising availabilities, and ad requests in the database 502, and may query the database 520 to obtain these data. In block 715, the system 500 determines if an ad request was received at the ad server 42 or the Web server 24. If in block 715, an ad request was not received, the method 700 moves to block 725 and the system 500 computes actual revenue as zero. In block 715, it an ad request was received, the method 700 moves to block 720 and the system 500 determines if an advertisement was served in response to the ad request. In the example of FIGS. 7A and 7B, a monetizable view is determined to exist if an advertisement was requested and served. Thus, if an ad was not served in the advertising availability, the method 700 again moves to block 725 and the system computes actual revenue as zero. Following block 725, the method 700 moves to block 770.

If in block 720 the system 500 determines that an advertisement was served in response to the ad request, the method 700 moves to block 730 and the system 500 retrieves the ad request from the database 520. In block 735, the system 500 parses the ad request to identify factors constituting the ad request. For example, the parsed ad request may identify the country and demographic signals such as gender and age. In block 740, for each factor i, the system 500 determines the format of the ad requested (e.g., pre-roll, instream, overlay).

In block 755, the system 500 retrieves or computes RPM for the actual ad format. The method 700 then moves to block 760 and the system 500 computes actual ad revenue. Following block 760, the method 700 moves to block 765.

In block 765, the system 500 determines if the i^{th} factor was the last factor for computing potential revenue. If there are more factors i to consider, the method 700 returns to block 740. If there are no more factors to consider, the method 700 moves to block 770 and the system 500 computes total potential revenue. In block 775, the system 500 computes missed revenue as potential revenue minus actual revenue. The method 700 then moves to block 780 and ends.

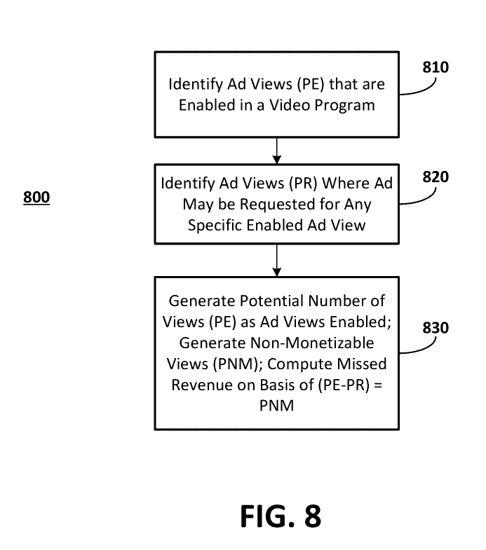

FIG. 8 illustrates an alternate method for computing potential and missed revenue. In FIG. 8, method 800 begins in block 810 when the system 500 identifies ad views (PE) that are enabled in a video program. In block 820, the system 500 identifies ad views (PR) where an advertisement may be requested for any specific enabled ad view. The ad views PR may differ from the ad views PE because of legal restrictions on serving ads, use of ad blockers, or because an ad was recently shown, for example. In block 830, the system 500 computes missed revenue on the basis of the difference between PE and PR; i.e., on the basis of non-monetizable views PNM=(PE−PR). The method 500 then ends.

Certain of the devices shown in FIGS. 1A, 1B, and 5 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flowcharts and accompanying description to illustrate the various embodiments. The disclosed devices, components, and systems contemplate using or implementing any suitable technique for performing the steps illustrated. Thus, FIGS. 6A-8 are for illustration purposes only and the described or similar steps may be performed at any appropriate time, including concurrently, individually, or in combination. In addition, many of the steps in the flow chart may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

1-20. (canceled)

21. A method comprising:
receiving a first value corresponding to a first number of monetizable views of a video, the first number of monetizable views being associated with a first factor;
receiving a second value corresponding to a second number of monetizable views of the video, the second number of monetizable views being associated with a second factor;
determining that the video viewed in association with the first factor was served with an ad in a first ad format but was requested to be served with an ad in a second ad format;
determining that the video viewed in association with the second factor was served with an ad in a third ad format but was requested to be served with an ad in a fourth ad format;
calculating, by a processor, a first revenue term value based on the first factor and the second ad format;
calculating, by the processor, a second revenue term value based on the second factor and the fourth ad format;
calculating, based on the first number of monetizable views of the video, the second number of monetizable views of the video, the first revenue term, and the second revenue term, a total potential revenue for the video if the video is served with advertisements in at least one of the second ad format or the fourth ad format;
determining, based on the total potential revenue, a missed revenue for the video to improve a selection of ad formats for advertisements to be served with the video, the missed revenue resulted from serving the video with advertisements in the first ad format and the third ad format instead of advertisements in the second ad format and the fourth ad format; and
providing the missed revenue of the video for presentation to a video provider.

22. The method of claim 21, further comprising:
accessing, by the processor, the first ad request and the second ad request;
determining, by the processor, the first ad format and the first factor specified in the first ad request;
determining the second ad format and the second factor specified in the second ad request; and
computing the total potential revenue of the video.

23. The method of claim 21, wherein the first factor and the second factor comprise a demographic factor of the first and the second monetizable views of the video.

24. The method of claim 21, wherein the first factor and the second factor indicate a content of the video.

25. The method of claim 21, wherein determining the missed revenue comprises subtracting an actual revenue associated with the video from the total potential revenue.

26. The method of claim 21, further comprising:
logging the first and the second ad requests in a data store; and
accessing, by the processor, one or more of the first and the second logged ad requests.

27. The method of claim 21, wherein first and the second ad formats comprise at least one of: instream and pre-roll video ad formats, overly ad formats, or banner ad formats.

28. A system comprising:
a memory;
a processor, operatively coupled to the memory, the processor to:
receive a first value corresponding to a first number of monetizable views of a video, the first number of monetizable views being associated with a first factor;
receive a second value corresponding to a second number of monetizable views of the video, the second number of monetizable views being associated with a second factor;
determine that the video viewed in association with the first factor was served with an ad in a first ad format but was requested to be served with an ad in a second ad format;
determine that the video viewed in association with the second factor was served with an ad in a third ad format but was requested to be served with an ad in a fourth ad format;
calculate a first revenue term value based on the first factor and the second ad format;
calculate a second revenue term value based on the second factor and the fourth ad format;
calculate, based on the first number of monetizable views of the video, the second number of monetizable views of the video, the first revenue term, and the second revenue term, a total potential revenue for the video if the video is served with advertisements in at least one of the second ad format or the fourth ad format;
determine, based on the total potential revenue, a missed revenue for the video to improve a selection of ad formats for advertisements to be served with the video, the missed revenue resulted from serving the video with advertisements in the first ad format and the third ad format instead of advertisements in the second ad format and the fourth ad format; and
provide the missed revenue of the video for presentation to a video provider.

29. The system of claim 28, the processor further to:
access the first ad request and the second ad request;
determine the first ad format and the first factor specified in the first ad request;
determine the second ad format and the second factor specified in the second ad request; and
compute the total potential revenue of the video.

30. The system of claim 28, wherein the first factor and the second factor comprise a demographic factor of the first and the second monetizable views of the video.

31. The system of claim 28, wherein the first factor and the second factor indicate a content of the video.

32. The system of claim 28, wherein to determine the missed revenue the processor is further to subtract an actual revenue associated with the video from the total potential revenue.

33. The system of claim 28, the processor further to:
log the first and the second ad requests in a data store; and
access one or more of the first and the second logged ad requests.

34. The system of claim 28, wherein first and the second ad formats comprise at least one of: instream and pre-roll video ad formats, overly ad formats, or banner ad formats.

35. A non-transitory computer readable medium with instructions stored thereon that, when executed by a processor, cause the processor to:
receive a first value corresponding to a first number of monetizable views of a video, the first number of monetizable views being associated with a first factor;
receive a second value corresponding to a second number of monetizable views of the video, the second number of monetizable views being associated with a second factor;
determine that the video viewed in association with the first factor was served with an ad in a first ad format but was requested to be served with an ad in a second ad format;
determine that the video viewed in association with the second factor was served with an ad in a third ad format but was requested to be served with an ad in a fourth ad format;
calculate a first revenue term value based on the first factor and the second ad format;
calculate a second revenue term value based on the second factor and the fourth ad format;
calculate, based on the first number of monetizable views of the video, the second number of monetizable views of the video, the first revenue term, and the second revenue term, a total potential revenue for the video if the video is served with advertisements in at least one of the second ad format or the fourth ad format;
determine, based on the total potential revenue, a missed revenue for the video to improve a selection of ad formats for advertisements to be served with the video, the missed revenue resulted from serving the video with advertisements in the first ad format and the third ad format instead of advertisements in the second ad format and the fourth ad format; and
provide the missed revenue of the video for presentation to a video provider.

36. The non-transitory computer readable medium of claim 35, the processor further to:
access the first ad request and the second ad request;
determine the first ad format and the first factor specified in the first ad request;
determine the second ad format and the second factor specified in the second ad request; and
compute the total potential revenue of the video.

37. The non-transitory computer readable medium of claim 35, wherein the first factor and the second factor comprise a demographic factor of the first and the second monetizable views of the video.

38. The non-transitory computer readable medium of 35 wherein the first factor and the second factor indicate a content of the video.

39. The non-transitory computer readable medium of claim 35, wherein to determine the missed revenue the processor is further to subtract an actual revenue associated with the video from the total potential revenue.

40. The non-transitory computer readable medium of claim 35, wherein first and the second ad formats comprise at least one of: instream and pre-roll video ad formats, overly ad formats, or banner ad formats.
